(19) United States
(12) Patent Application Publication
(10) Pub. No.: US 2016/0023923 A1
(43) Pub. Date: Jan. 28, 2016

(54) IODINE ADSORBENT, WATER TREATMENT TANK AND IODINE ADSORBING SYSTEM

(71) Applicant: Kabushiki Kaisha Toshiba, Minato-ku (JP)

(72) Inventors: Tomohito IDE, Inagi (JP); Yumiko SEKIGUCHI, Kawasaki (JP); Toshihiro IMADA, Kawasaki (JP)

(73) Assignee: Kabushiki Kaisha Toshiba, Minato-ku (JP)

(21) Appl. No.: 14/798,808

(22) Filed: Jul. 14, 2015

(30) Foreign Application Priority Data
Jul. 24, 2014 (JP) 2014-151074

(51) Int. Cl. C02F 1/28; C02F 1/00; C07F 7/18; B01J 20/22; B01J 20/289

(52) U.S. Cl. CPC C02F 1/285; B01J 20/223; B01J 20/289; C07F 7/1836; C02F 1/008; C02F 2101/12

(57) ABSTRACT

An iodine adsorbent of an embodiment has a support, a first organic group bonded to the support and has a functional group containing nitrogen at least at a terminal, and silver bonded to the nitrogen-containing functional group.

### CROSS-REFERENCE TO RELATED APPLICATION

This application is based upon and claims the benefit of priority from Japanese Patent Application No. 2014-151074 Jul. 24, 2014; the entire contents of which are incorporated herein by reference.

### FIELD

Embodiments described herein relate to an iodine adsorbent, a water treatment tank and an iodine adsorbing system.

### BACKGROUND

Iodine is used for pharmaceutical products such as X-ray contrast agents and germicides, intermediate materials and catalysts for chemical synthesis, herbicides and feed additives, and in addition, polarizing plates for LCD have recently come into use, thus increasing the demand for iodine. On the other hand, iodine is required to be collected and recycled from wastewater because there are few concentrated resources of iodine in nature, and in recent years, environmental regulations have been tightened. In case of nuclear disaster, iodine is released into the air, and dissolved in rain water, river water and the like to cause a problem.

Iodine can be selectively adsorbed using silver-supported activated carbon or zeolite. Unfortunately, silver-supported materials do not have high adsorption capacity although they are selective for iodide ions. In addition, silver-supported activated carbon, which is produced by immersing activated carbon in a solution containing silver ions, cannot have a high silver content because silver ions can easily dissolve in water. Silver-supported zeolite, which is produced by cation exchange, can undergo ion exchange again in the presence of other cations so that silver may dissolve.

### BRIEF DESCRIPTION OF THE DRAWINGS

FIG. 1 is a conceptual view of an iodine adsorbing system of an embodiment; and

FIG. 2 is a sectional schematic view of a water treatment tank of an embodiment.

### DETAILED DESCRIPTION

An iodine adsorbent of an embodiment has a support, a first organic group bonded to the support and has a functional group containing nitrogen at least at a terminal, and silver bonded to the nitrogen-containing functional group.

A water treatment tank of an embodiment has an iodine adsorbent. The iodine adsorbent of an embodiment is stored in the tank. The iodine adsorbent of an embodiment has a support, a first organic group bonded to the support and has a functional group containing nitrogen at least at a terminal, and silver bonded to the nitrogen-containing functional group.

An iodine adsorbing system of an embodiment includes a supply unit configured to supply, to the adsorbent unit, target medium water containing an iodide; a discharge unit configured to discharge the target medium water from the adsorbent unit; a measuring unit provided on at least one of supply and discharge sides of the adsorbent unit and configured to measure a concentration of the iodide in the target medium water; and a controller configured to control a flow of the target medium water from the supply unit to the adsorbent unit when a value calculated or obtained from a measured value in the measuring unit reaches a set value. The iodine adsorbent has a support, a first organic group bonded to the support and has a functional group containing nitrogen at least at a terminal, and silver bonded to the nitrogen-containing functional group.

(Iodine Adsorbent)

An iodine adsorbent of an embodiment includes a support and an organic group bonded to the support. The iodine adsorbent preferably includes a first organic group containing a nitrogen functional group at least at a terminal of the first organic group. The iodine adsorbent preferably further includes a second organic group containing a sulfur functional group at a terminal of the second organic terminal. The silver is bonded to nitrogen or sulfur.

In the embodiment, the support is preferably a member capable of imparting, to the iodine adsorbent, a strength that makes the iodine adsorbent practically usable. The support, into which the organic group is to be introduced, is preferably such that it has a large number of hydroxyl groups on its surface so that it can be modified with a high content of functional groups by the production method described below. The support to be used may be an acidic support or a neutral support obtained by neutralizing an acidic support in advance. The neutralizing may be, for example, treating the support in an additive such as calcium ions. Specifically, the support with such features may be at least one of silica gel (SiO₂, neutral or acidic), a metal oxide, an acrylic resin, and the like.

Examples of the metal oxide support may derived from silica (SiO₂), titania (TiO₂), alumina (Al₂O₃), zirconia (ZrO₂), ferrous oxide (FeO), ferric oxide (Fe₂O₃), triiron tetraoxide (Fe₃O₄), cobalt trioxide (CoO₃), cobalt oxide (CoO), tungsten oxide (WO₃), molybdenum oxide (MoO₃), indium tin oxide (In₂O₃—SnO₂, ITO), indium oxide (In₂O₃), lead oxide (PbO₂), niobium oxide (Nb₂O₅), thorium oxide (ThO₂), tantalum oxide (Ta₂O₅), rhenium trioxide (ReO₃), and chromium oxide (Cr₂O₃); and oxometalates such as zeolite (aluminosilicate), lead zirconate titanate (Pb(ZrTi)O₃, PZT), calcium titanate (CaTiO₃), lanthanum cobaltate (LaCoO₃), lanthanum chromate (LaCrO₃), and barium titanate (BaTiO₃); or alkoxides or halides capable of forming the above.

Among the supports listed above, silica, titania, alumina, zirconia, and zeolite are advantageous in that they are inexpensive and have a high content of hydroxyl groups on the surface so that the support can be modified with a large number of ligands.

The support may also be an acrylic resin. An acrylic resin has a sufficient strength by itself, can impart, to the iodine adsorbent, a strength that makes the iodine adsorbent practically usable, and has an ester bond. Therefore, an acrylic resin can be modified with a high content of organic groups by transesterification. When synthesized, an acrylic resin can form a glycidyl skeleton-containing support. For example, therefore, the support may be synthesized using glycidyl methacrylate or the like as a monomer, so that the support can be modified with a high content of organic groups.

In the embodiment, the support preferably has an average primary particle size of 100 μm to 5 mm with respect to its size. When the support has an average primary particle size of 100 μm to 5 mm, for example, not only a storing ratio of the iodine adsorbent in a column, cartridge, or tank can be made high, but also water can smoothly flow through the stored column cartridge, or tank, in the process of performing iodine adsorption. If the average primary particle size is less than 100 μm, a storing ratio of the iodine adsorbent in a column or the like can be too high, which can reduce a void ratio and thus make it difficult to allow water to flow through the column or the like. On the other hand, if the average primary particle size is more than 5 mm, a storing ratio of the iodine adsorbent in a column or the like can be too low, so that the iodine adsorbent can have a smaller contact area with iodine-containing wastewater and thus can have a smaller iodine adsorption capacity, although void will increase to allow water to easily flow through. The support preferably has an average primary particle size of 100 μm to 2 mm, more preferably 100 μm to 300 μm or 300 μm to 1 mm. When the average primary particle size is from 100 μm to 300 μm, the iodine adsorbent can have a larger specific surface area, which is preferred. When the average primary particle size is from 300 μm to 1 mm, the pressure loss during water flow can be reduced, which is preferred.

The average primary particle size can be measured by a sieving method. Specifically, according to JIS Z 8901 (2006) “Test Powder and Test Particles,” the average primary particle size can be measured by sieving particles through a plurality of sieves with apertures between 100 μm and 5 mm.

The size of the iodine adsorbent of this embodiment can be controlled only by changing the size of the support. This means that the size of the support may be set at a specific value so that an easily-handleable adsorbent can be obtained. Therefore, an easily-handleable iodine adsorbent can be obtained without granulation and other processes. When granulation and other processes do not need to be performed, the manufacturing process necessary for the production of an easily-handleable iodine adsorbent can be simplified, which makes it possible to reduce costs.

The iodine adsorbent of the embodiment preferably includes an organic group (a first organic group) bonded to the support and has a nitrogen-containing functional group (nitrogen functional group) at least at a terminal of the first organic group. The first organic group contains a carbon chain. The adsorbent having the first organic group containing the nitrogen functional group at the terminal is preferred because it has a high ability to adsorb iodine. Nitrogen functional groups may be present at two or more terminals of the first organic group. The nitrogen functional group is preferably a functional group having an amine or amine derivative structure. The nitrogen functional group preferably includes, for example, at least one of an amino group, an amide group, a guanidino group, and the like. The organic group may also include polyamine, polyamide, polyguanidine, or the like in which the nitrogen functional groups are linked through a carbon chain such as an alkyl chain. A compound, such as a coupling agent, having a nitrogen functional group at a terminal of the compound may be allowed to react with the support (the hydroxyl or epoxy groups on the surface of the support) so that the first organic group can be introduced into the support. A linker between the support and the first organic group depends on the compound which is used to introduce the first organic group to the support. When a coupling agent is used to introduce the first organic group, the structure between the terminal nitrogen atom and the oxygen atom bonded to the support preferably includes, for example, a carbon chain such as an alkyl, alkoxy, aminoalkyl, or ether chain having a linear or branched chain of 1 to 6 carbon atoms. The method for detecting the nitrogen functional group at the terminal of the first organic group is preferably solid-state NMR (Nuclear Magnetic Resonance) analysis of the iodine adsorbent.

In an embodiment, silver is bonded to the nitrogen functional group. The iodine adsorbent functions by allowing the silver to bind to iodine (iodide ions). When silver is in the form of an ion, a monovalent silver ion is preferred. The iodine adsorbent may also contain zero-valent silver.

The adsorbent may contain an anion as a counter ion for the silver ion. The counter ion for the silver ion is preferably an ion capable of forming a water-soluble salt, such as fluoride ion, nitrate ion, sulfate ion, acetate ion, trifluoroacetate ion, methanesulfonate ion, tri fluoromethanesulfonate ion, toluenesulfonate ion, chlorate ion, carbonate ion, nitrite ion, sulfite ion, lactate ion, citrate ion, salicylate ion, hexafluorophosphate ion, or tetrafluoroborate ion. Among them, nitrate and sulfate ions are preferred because they are inexpensive and safe and do not form an anionic metal complex. These counter ions may be derived from a silver salt, which is used to introduce the silver ion (silver) into the adsorbent.

The iodine adsorbent of the embodiment preferably further includes an organic group (second organic group) bonded to the support and has a sulfur-containing functional group (sulfur functional group) at least at a terminal of the second organic group. The second organic group contains a carbon chain. The adsorbent including both of the first organic group having the nitrogen functional group at least at the terminal and including the second organic group having the sulfur functional group at least at the terminal is preferred because it has a higher ability to adsorb iodine than the adsorbent including the first organic group having only a sulfur functional group at a terminal or the adsorbent including the second organic group having only a nitrogen functional group at a terminal and because silver is less likely to dissolve from it. Sulfur functional groups may be present at two or more terminals of the second organic group. The sulfur functional group preferably includes, for example, at least one of a thiol group, a thiolate group (S⁻), a sulfide group, a disulfide group, and the like. The second organic group may also include a thioester or the other sulfide in which the sulfur functional groups are linked through a carbon chain such as an ester. A compound, such as a coupling agent, having the sulfur functional group at a terminal of the compound may be allowed to react with the support so that the second organic group can be introduced into the support. A linker between the support and the second organic group depends on the compound used to introduce the second organic group. The method for detecting the sulfur functional group at the terminal of the second organic group is preferably solid-state NMR analysis of the iodine adsorbent.

In the embodiment, silver is bonded to the sulfur atom of the sulfur functional group. The iodine adsorbent functions by allowing the silver to bind to iodine (iodide ions). When silver is in the form of an ion, a monovalent silver ion is preferred. The iodine adsorbent may also contain zero-valent silver.

For example, zero-valent silver is produced when silver ions are reduced by the nitrogen or sulfur functional group present on the surface, an organic material, or light.

An atomic concentration ratio (S (atom %)/N (atom %)) of sulfur to nitrogen in the iodine adsorbent preferably has an upper limit of less than 2.0. In view of the ability to adsorb iodine, the sulfur atom of the sulfur functional group and silver are preferably bonded in a ratio ([sulfur]:[silver]) of 1:1. However, if sulfur is too much relative to nitrogen, the mode in which sulfur and silver are bonded in a ratio ([sulfur]:[silver]) of n:1 (n is an integer of 2 to 6) will increase. This mode is not preferred because in this mode, silver will have a lower binding power to iodine, so that the ability to adsorb iodine will decrease. For the reasons mentioned above, the atomic concentration ratio (S (atom %)/N (atom %)) of sulfur to nitrogen in the iodine adsorbent is preferably 1.8 or less, more preferably 1.6 or less. For an increase in the amount of adsorption and for highly selective adsorption of iodine, the atomic concentration ratio (S (atom %)/N (atom %)) of sulfur to nitrogen in the iodine adsorbent is preferably 1.4 or less, more preferably 0.8 or less, even more preferably 0.5 or less.

The lower limit of the atomic concentration ratio (S (atom %)/N (atom %)) of sulfur to nitrogen in the iodine adsorbent is not limited and 0 or more. The lower limit of the atomic concentration ratio (S (atom %)/N (atom %)) of sulfur to nitrogen in the iodine adsorbent including the second organic group having a sulfur functional group at the terminal is more than 0. The atomic concentration ratio (S (atom %)/N (atom %)) of sulfur to nitrogen in the iodine adsorbent is preferably 0.1 or more, more preferably 0.4 or more. In view of the above, the iodine adsorbent may have the atomic concentration ratio (S (atom %)/N (atom %)) of sulfur to nitrogen in the range of 0 to less than 2.0, typically in the range of 0.1 to 1.8, preferably in the range of 0.4 to 1.6, in which the preferred range can be defined by selecting the upper and lower limits mentioned above. The concentration of nitrogen atoms (N (atoms %)) in the iodine adsorbent is defined as a ratio of nitrogen atoms to all atoms, exclusive of hydrogen, in the iodine adsorbent. The concentration of sulfur atoms (S (atoms %)) in the iodine adsorbent is defined as a ratio of sulfur atoms to all atoms, exclusive of hydrogen, in the iodine adsorbent. As used herein, the term “all atoms” refers to atoms that are contained in the reagents used in the synthesis process and thus expected to be present in the iodine adsorbent. The term “all atoms” is not intended to include unintentional contaminant atoms such as impurities in the reagents.

If a concentration of carbon atoms in the iodine adsorbent (the ratio of carbon atoms to all atoms, exclusive of hydrogen, in the iodine adsorbent) is too high, the first organic group, the second organic group or both of the first organic group and the second organic group can have highly hydrophobic properties. This can make it difficult to bond silver to the nitrogen or sulfur atom of the nitrogen or sulfur functional group, so that the ability to adsorb iodine can decrease. Therefore, the concentration of carbon atoms in the iodine adsorbent is preferably 50 (atm %) or less. The concentration of carbon atoms in the iodine adsorbent is more preferably 40 (atm %) or less, even more preferably 30 (atm %) or less, further more preferably 21 (atm %) or less. If the concentration of carbon atoms is too low, the amount of silver capable of adsorbing iodine will be small, which can reduce the ability to adsorb iodine and therefore is not preferred. Therefore, the concentration of carbon atoms in the iodine adsorbent is preferably 10 (atm %) or more, more preferably 15 (atm %) or more.

In view of the above, the concentration of carbon atoms in the iodine adsorbent may be in the range of 10 (atm %) to 50 (atm %), for example, preferably in the range of 15 (atm %) to 40 (atm %), in which the preferred range can be defined by selecting the upper and lower limits mentioned above. The preferred concentration of carbon atoms is in common between the iodine adsorbent including the first organic group having the nitrogen functional group at the terminal and the iodine adsorbent including the first organic group having the nitrogen functional group at the terminal and the second organic group having the sulfur functional group at the terminal.

Nitrogen atoms, sulfur atoms, carbon atoms, and other elements in the iodine adsorbent can be quantified using elementary analysis, X-ray spectroscopy (such as energy dispersive X-ray spectroscopy (EDX) or X-ray photoelectron spectroscopy (XPS)), solid-state NMR, or the like. When the counter ion for silver contains nitrogen or sulfur, the counter ion for silver should be replaced with a chloride ion by immersing the iodine adsorbent in an aqueous sodium chloride solution, so that the correct concentration of nitrogen or sulfur in the iodine adsorbent itself can be determined.

The above values were determined using a plurality of iodine adsorbent samples, which had a 2-aminoethylamino group as a nitrogen functional group and a thiol group as a sulfur functional group and carried silver nitrate and which were synthesized with different mixing ratios of a silane coupling agent. Before the measurement, the samples were immersed in an aqueous sodium chloride solution so that the nitrate ion was replaced with the chloride ion, and then the samples were washed with water and dried under reduced pressure. The contents of nitrogen and sulfur were measured by SEM-EDX (Scanning Electron Microscope-Energy Dispersive X-ray Spectroscopy).

When the concentration of carbon atoms is high, an organic group having a hydrophilic functional group such as a hydroxyl group (although silver cannot be easily bonded to such a hydrophilic functional group) may be bonded to the support, so that hydrophilicity can be imparted to the iodine adsorbent. This makes it possible to increase the amount of the carried silver and improve the ability to adsorb iodine. Other organic groups having no nitrogen or sulfur functional group may also be bonded to the support.

It is considered that when the iodine adsorbent of the embodiment is used, the silver or silver ion as a component of the adsorbent can adsorb iodide ions in wastewater. Specifically, it is considered that in wastewater, iodine (I) can be present in the form of anions such as iodide ions (I⁻), polyiodide ions (I₃⁻, I₅⁻), and iodate ions (IO₃⁻) and that such anions can interact with the silver or silver ion in the iodine adsorbent, so that the iodine adsorbent can adsorb iodine in wastewater.

(Method for Producing Iodine Adsorbent)

A method for producing the iodine adsorbent of the embodiment will now be described. It will be understood that the production method described below is a non-limiting example and that any other method capable of producing the iodine adsorbent of the embodiment is also possible. It should be noted that after each treatment, filtration, washing with pure water, alcohol, or the like, and drying are preferably performed before the next treatment.

A method for producing the iodine adsorbent of the embodiment includes the steps of: bonding, to a support, a first organic group having a nitrogen functional group at least at a terminal of the first organic group or bonding, to a support, both of a first organic group having a nitrogen functional group at least at a terminal of the first organic group and a second organic group having a sulfur functional group at least at a terminal of the second organic group; and bringing a silver-containing organic or inorganic salt into contact with the support to which the first organic group or both of the first organic group and the second organic group are bonded.

The support having the first organic group containing the nitrogen functional group at least at the terminal or the support having the first organic group containing the nitrogen functional group at least at the terminal and the second organic group containing the sulfur functional group at least at the terminal can be obtained as follows. Hydroxyl or epoxy groups on the surface of the support are allowed to react with a compound having the first organic group containing the nitrogen functional group at least at the terminal or allowed to react with a compound having the first organic group containing the nitrogen functional group at least at the terminal and a compound having the second organic group containing the sulfur functional group at least at the terminal. This reaction makes it possible to introduce the first organic group or both of the first organic group and the second organic group into the support. Alternatively, a support having an amine on its surface may be used. In this case, the first organic group or both of the first organic group and the second organic group can be introduced into the support by using a compound capable of undergoing a nucleophilic reaction with the amine on the support surface.

The compound having the first organic group containing the nitrogen functional group at least at the terminal or the compound having the second organic group containing the sulfur functional group at least at the terminal may be a coupling agent capable of reacting with a hydroxyl group or a compound having, at a terminal, an amino or thiol group capable of reacting with an epoxy group, other than the nitrogen or sulfur functional group.

Examples of the coupling agent include a silane coupling agent, a titanate coupling agent, an aluminate coupling agent, and the like. A coupling agent capable of forming an ester by coupling with a hydroxyl group on the surface, such as a phosphonic acid or a carboxylic acid, may also be used.

Examples of a coupling agent having a nitrogen functional group at a terminal include N-(2-ethylamino)-3-aminopropyltrimethoxysilane, N-(2-ethylamino)-3-aminopropyltriethoxysilane, N-(2-ethylamino)-3-aminopropyldimethoxysilane, N—(N-(2-ethylamino)-2-ethylamino)propyltrimethoxysilane, 3-aminopropyltrimethoxysilane, 3-aminopropyldiethoxymethylsilane, N,N-bis(2-aminoethyl)-3-aminopropyltrimethoxysilane, 3-(1,4,7,10-tetraazacyclododecyl)propyltrimethoxysilane, N,N-di(2-pyridylmethyl)-3-aminopropyltriethoxysilane, 3-guanidylpropyltrimethoxysilane, 2-[2-[[bis(isopropylamino)methylene]amino]ethyl-9,9-dimethoxy-N′,N″-diisopropyl-5-[(isopropylamino)(isopropylimino)methyl]-10-oxa-2,5-diaza-9-silaundecanimidamide, N-acetyl-3-aminopropyltrimethoxysilane, N-(2-propenylcarbonyl)-3-aminopropyltrimethoxysilane, N-[2-(acetylamino)ethyl]-3-aminopropyltrimethoxysilane, and the like. When the support has an epoxy group, the epoxy group can be allowed to react with an amine such as ethylenediamine, diethylenetriamine, triethylenetetramine, or polyethyleneimine so that a nitrogen functional group can be introduced into the support. The support into which an amine has been introduced may be further treated with acetyl chloride, acetic anhydride, acryl chloride, methacryl chloride, acrylamide, or the like, so that an amide group can be introduced. The support may also be treated with 1-amidinopyrazole hydrochloride, so that a guanidyl group can be introduced.

Examples of a coupling agent having a sulfur functional group at a terminal include a thiol coupling agent such as 3-sulfanylpropyltrimethoxysilane, 3-sulfanylpropyltriethoxysilane, 3-mercaptopropylmethyldimethoxysilane, bis[3-(trimethoxysilyl)propyl]disulfide, 3-(methylthio)propyltrimethoxysilane, S-acetyl-3-mercaptopropyltrimethoxysilane, or sodium 3-(triethoxysilyl)propylthiolate, a sulfide coupling agent such as bis(triethoxysilylpropyl)tetrasulfide, and coupling agents such as sulfanyl titanate, sulfanyl aluminum chelate, and sulfanyl zircoaluminate. The support having an epoxy group may be allowed to react with sodium hydrosulfide, potassium hydrosulfide, or the like, so that a thiol group can be introduced. A thiolate group can be obtained by treating a thiol group with sodium, potassium, or the like. A thiol group may also be allowed to react with acetyl chloride, acetic anhydride, acryl chloride, methacryl chloride, or the like, so that a thioester group can be introduced. When a thiol group is treated with an oxidizing agent such as hydrogen peroxide or iodine, a disulfide group can be produced. An epoxy group may be treated with hydrochloric acid, hydrobromic acid, or hydroiodic acid and then allowed to react with sodium disulfide, so that a disulfide group can be obtained.

The coupling agent can be allowed to react with the support by a method of vaporizing the coupling agent so that it can react with the support, a method of mixing the coupling agent into a solvent and then mixing the support so that they can react, or a method of bringing the coupling agent directly into contact with the support with no solvent so that they can react. In each reaction process, heating or reducing pressure may be performed so that the amount (content) of sulfur introduced into the iodine adsorbent can be controlled.

The reaction solvent is more preferably an aromatic solvent. The reaction solvent may also be an alcohol, a mixed solvent of an alcohol and water, or any other solvent capable of dissolving the coupling agent having a nitrogen or sulfur functional group. Concerning the reaction temperature, the treatment may be performed at high temperature particularly when an aromatic solvent is used, which is advantageous in that the rate of modification with the ligand can be increased. On the other hand, in a water-soluble solvent, the treatment is preferably performed at lower temperature, because in the water-soluble solvent, the coupling agent can easily undergo hydrolysis so that a condensation reaction can easily occur between the coupling agent molecules.

Subsequently, the support obtained as described above is allowed to carry silver ions. Examples include a method that includes preparing an aqueous solution of a silver salt of an inorganic or organic acid and then immersing and stirring the organic group-carrying support in the aqueous solution; and a method that includes storing a column with the support and allowing the aqueous solution to flow into the column.

Examples of the silver salt of an inorganic or organic acid include silver nitrate, silver sulfate, silver acetate, silver trifluoroacetate, silver methanesulfonate, silver trifluoromethanesulfonate, silver toluenesulfonate, silver chlorate, silver carbonate, silver nitrite, silver sulfite, silver lactate, silver citrate, silver salicylate, silver hexafluorophosphate, silver tetrafluoroborate, and the like. In view of solubility in water, silver nitrate is preferred.

In the above description of the production method, coupling agents are shown as typical examples of the compound for introducing the nitrogen- or sulfur-containing functional group into the surface of the support. Alternatively, the first organic group having a nitrogen or the second organic group having a sulfur functional group may be introduced using known reaction schemes. After the iodine adsorbent is produced, the counter ion for the silver ion may be replaced with, for example, a chloride ion or any other ion whose binding power is smaller than that of an iodide ion. The counter ion for the silver ion can be replaced with a chloride ion by a method that includes immersing the iodine adsorbent in a chloride ion-containing solution, stirring the solution, and drying the adsorbent.

(Iodine Adsorbing System and Method for Using Iodine Adsorbent)

An adsorbing system using the iodine adsorbent described above and a method for using the iodine adsorbent will now be described. An iodine adsorbing system includes a supply unit configured to supply, to the adsorbent unit, target medium water containing an iodide; a discharge unit configured to discharge the target medium water from the adsorbent unit; a measuring unit provided on at least one of supply and discharge sides of the adsorbent unit and configured to measure a concentration of the iodide in the target medium water; and a controller configured to control a flow of the target medium water from the supply unit to the adsorbent unit when a value calculated or obtained from a measured value in the measuring unit reaches a set value.

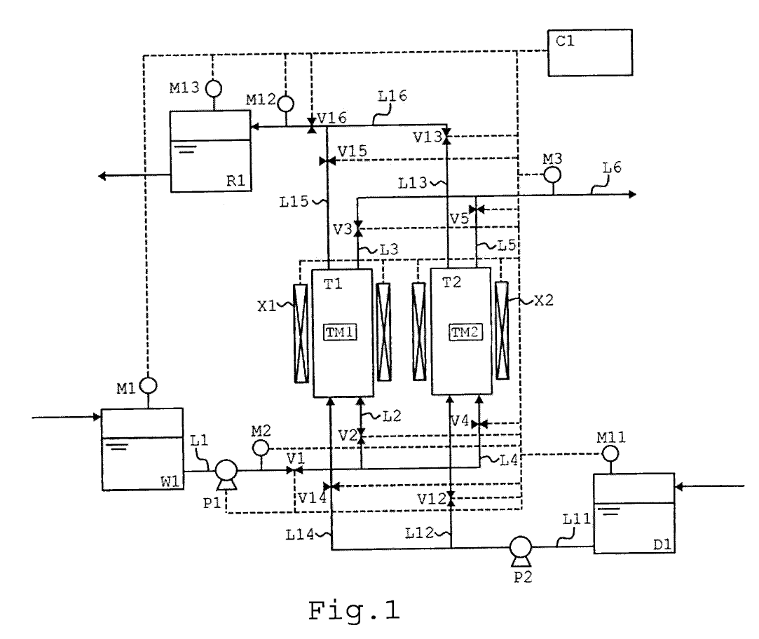

FIG. 1 is a schematic diagram showing the outlined configuration of an apparatus for use in iodine adsorption and a treatment system in this embodiment.

As shown in FIG. 1, in this apparatus, water treatment tanks T1 and T2 each stored with the iodine adsorbent are arranged side by side, and contact efficiency promoting units X1 and X2 are provided outside the water treatment tanks T1 and T2. The contact efficiency promoting units X1 and X2 may be mechanical stirrers or non-contact magnetic stirrers, but are not essential components, and therefore may be omitted.

The water treatment tanks (adsorbing units) T1 and T2 are connected through wastewater supply lines (supply units) L1, L2, and L4 to a wastewater storing tank W1 storing wastewater (target medium water) containing an iodide (iodide ions), and are also connected to the outside through wastewater discharge lines (discharge units) L3, L5, and L6.

The supply lines L1, L2, and L4 are provided with valves (control units) V1, V2, and V4, respectively, and the discharge lines L3 and L5 are provided with valves V3 and V5, respectively. The supply line L1 is provided with a pump P1. Further, the wastewater storing tank W1, the supply line L1, and the discharge line L6 are provided with concentration measuring units (measuring units) M1, M2, and M3, respectively.

A controller C1 is provided to conduct collective centralized management of the control of the valves and the pump and the monitoring of the measurements in the measurement apparatus.

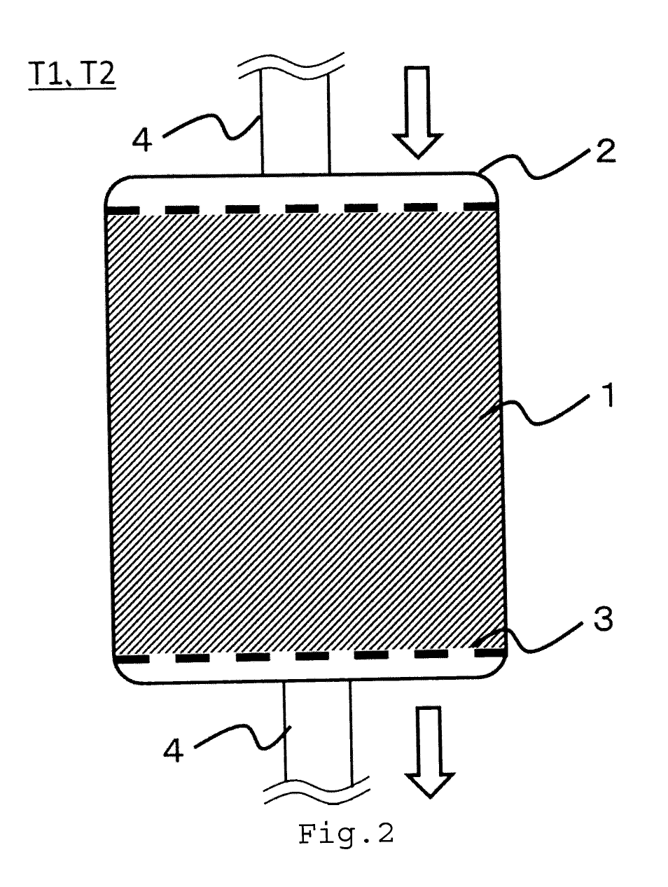

FIG. 2 is a schematic sectional view showing the water treatment tanks T1 and T2 connected to pipes 4 (L2 to L4) and stored with the iodine adsorbent. The arrow in the drawing indicates the direction in which the target water flows. The water treatment tanks T1 and T2 each include an iodine adsorbent 1; a tank 2 storing the iodine adsorbent; and a partition plate 3 provided to prevent the iodine adsorbent from leaking out of the tank 2. The water treatment tanks T1 and T2 may be of a cartridge type that allows the tank 2 itself to be replaced, or may be of a type that allows the iodine adsorbent in the tank 2 to be replaced. When there are other substances to be adsorbed and collected in addition to halogen, other adsorbents may be stored in the tank 2.

Halogen (iodine) adsorption operations using the apparatus shown in FIG. 1 will now be described.

First, wastewater is supplied from the tank W1 through the wastewater supply lines L1, L2, and L4 to the water treatment tanks T1 and T2 by the pump P1. At this time, halogen in the wastewater is adsorbed to the water treatment tanks T1 and T2. After the adsorption, the wastewater is discharged to the outside through the wastewater discharge lines L3 and L5.

In this process, the contact efficiency promoting units X1 and X2 are driven as needed to increase the contact area between the wastewater and the iodine adsorbent stored in the water treatment tanks T1 and T2, so that the efficiency of adsorption of halogen by the water treatment tanks T1 and T2 can be improved.

In this process, the state of the adsorption in the water treatment tanks T1 and T2 are observed using the concentration measuring units M2 and M3 provided on the supply and discharge sides of the water treatment tanks T1 and T2. When adsorption is successfully performed, the concentration of halogen measured by the concentration measuring unit M3 is lower than the concentration of halogen measured by the concentration measuring unit M2. However, the difference between the halogen concentrations at the concentration measuring units M2 and M3 on the supply and discharge sides decreases as the adsorption of iodine in the water treatment tanks T1 and T2 proceeds.

Therefore, when a predetermined value set beforehand by the concentration measuring unit M3 is reached, so that it is determined that the halogen adsorbing capacity of the water treatment tanks T1 and T2 is saturated, the controller C1 temporarily stops the pump P1 and closes the valves V2, V3, and V4 to stop the supply of the wastewater to the water treatment tanks T1 and T2 according to the information from the concentration measuring units M2 and M3.

Although not illustrated in FIG. 1, the pH of the wastewater may be measured by the concentration measuring unit M1 and/or the concentration measuring unit M2 and adjusted through the controller C1 when the pH of the wastewater fluctuates or when the pH of the wastewater is strongly acidic or basic and falls outside the pH range suitable for the adsorbent according to this embodiment. The pH suitable for the iodine adsorption by the iodine adsorbent of the embodiment is, for example, from 2 to 8. It is actually difficult to control the pH of raw water for water supply, tap water, agricultural water, industrial water, and the like before they are subjected to the treatment. However, they may be treated without pH control.

After the water treatment tanks T1 and T2 are saturated, they are appropriately replaced with other water treatment tanks stored with a fresh iodine adsorbent. The water treatment tanks T1 and T2 saturated for the adsorption of iodine are appropriately subjected to a necessary post-treatment. For example, when the water treatment tanks T1 and T2 contain radioactive iodine, for example, the water treatment tanks T1 and T2 are crushed, then cemented, and stored as radioactive wastes in an underground facility or the like.

The example described above has shown a system and operations for adsorbing halogen in wastewater using a water treatment tank. Alternatively, halogen in waste gas can also be adsorbed and removed by allowing the halogen-containing waste gas to pass through a column as described above.

### EXAMPLES

### Example 1

An eggplant-shaped flask (100 mL) equipped with a magnetic stirrer and a Dimroth condenser was charged with 3-(2-aminoethyl)aminopropyltrimethoxysilane (9.4 mL, 44 mmol) and toluene (10 mL), and the mixture was stirred to form a uniform solution. Silica gel (particle size 300 μm to 500 μm, 6.7 g) with a water content of 30% was added to the solution and stirred with heating under reflux (oil bath at a temperature of 110° C.) for 5 hours. Subsequently, after the mixture was cooled to room temperature, the supernatant was removed by decantation. After methanol was further added for washing the residue, the supernatant was removed by decantation (washing with methanol and decantation were repeated twice). Subsequently, the silica gel was transferred to a Hirsch funnel and then washed with methanol. The suction was just continued for drying. The silica gel was then further dried under reduced pressure, so that amine-modified silica gel was obtained as a white powder (yield 6.42 g).

The amine-modified silica gel (0.93 g) was added to a vial (30 mL), to which a 3 wt % silver nitrate aqueous solution (18.6 mL) was added. The vial was capped and then covered with an aluminum foil for light shielding. The mixture was then stirred with a mixing rotor (60 rpm) for 1 hour. The silica gel was collected by suction filtration and then washed thoroughly with ion-exchanged water. The silica gel was transferred again to a vial (20 mL), which was then charged with water (20 mL) and capped. The vial was covered with an aluminum foil for light shielding, and the mixture was stirred with a mixing rotor (60 rpm) for 1 hour. The silica gel was collected by suction filtration and then dried under reduced pressure while shielded from light, so that an adsorbent of Example 1 (1.44 g) was obtained.

### Example 2

An eggplant-shaped flask (50 mL) equipped with a magnetic stirrer and a Dimroth condenser was charged with 3-mercaptopropyltrimethoxysilane (1.6 mL, 10 mmol), 3-(2-aminoethyl)aminopropyltrimethoxysilane (2.3 mL, 11 mmol), and toluene (5 mL), and the mixture was stirred to form a uniform solution. Silica gel (particle size 300 μm to 500 μm, 3.3 g) with a water content of 30% was added to the solution and stirred with heating under reflux (oil bath at a temperature of 110° C.) for 5 hours. After the mixture was cooled to room temperature, the liquid phase was removed by decantation. Subsequently, washing was performed by adding methanol (5 mL) to the flask, stirring the mixture, and removing the liquid phase by decantation (washing with methanol and decantation were repeated five times). The remaining silica gel was transferred to a Hirsch funnel and then washed with methanol. After the suction was just continued for drying, the silica gel was further dried under reduced pressure, so that amine- and thiol-modified silica gel was obtained as a white powder (yield 3.2 g).

The amine- and thiol-modified silica gel (0.50 g) was added to a vial (20 mL), to which a 3 wt % silver nitrate aqueous solution (10 mL) was added. The vial was capped and then covered with an aluminum foil for light shielding. The mixture was then stirred with a mixing rotor (60 rpm) for 1 hour. The silica gel was collected by suction filtration and then washed thoroughly with ion-exchanged water. The silica gel was transferred again to a vial (20 mL), which was then charged with water (20 mL) and capped. The vial was covered with an aluminum foil for light shielding, and the mixture was stirred with a mixing rotor (60 rpm) for 1 hour. The silica gel was collected by suction filtration and then dried under reduced pressure while shielded from light, so that an adsorbent of Example 2 (0.61 g) was obtained.

### Example 3

An iodine adsorbent of Example 3 was obtained as in Example 2, except that the amounts of the reagents were changed to 3-mercaptopropyltrimethoxysilane (2.5 mL, 16 mmol) and 3-(2-aminoethyl)aminopropyltrimethoxysilane (2.0 mL, 9.1 mmol).

### Example 4

An iodine adsorbent of Example 4 was obtained as in Example 2, except that the amounts of the reagents were changed to 3-mercaptopropyltrimethoxysilane (2.9 mL, 18 mmol) and 3-(2-aminoethyl)aminopropyltrimethoxysilane (1.3 mL, 5.8 mmol).

### Example 5

An iodine adsorbent of Example 5 was obtained as in Example 2, except that the amounts of the reagents were changed to 3-mercaptopropyltrimethoxysilane (3.4 mL, 21 mmol) and 3-(2-aminoethyl)aminopropyltrimethoxysilane (0.65 mL, 3.0 mmol).

### Example 6

An iodine adsorbent of Example 6 was obtained as in Example 2, except that the amounts of the reagents were changed to 3-mercaptopropyltrimethoxysilane (3.2 mL, 20 mmol) and 3-(2-aminoethyl)aminopropyltrimethoxysilane (0.39 mL, 1.8 mmol).

### Example 7

An iodine adsorbent of Example 7 was obtained as in Example 2, except that the amounts of the reagents were changed to 3-mercaptopropyltrimethoxysilane (3.1 mL, 29 mmol), 3-(2-aminoethyl)aminopropyltrimethoxysilane (4.7 mL, 1.5 mmol), and silica gel (6.7 g) with a water content of 30%, the solvent was changed from toluene to xylene (10 mL), and the oil bath temperature was changed to 113° C. The iodine adsorbent of Example 7 was examined for its ability to allow the silver to dissolve. The amount of silver dissolved from the iodine adsorbent of Example 7 was about one-third of the amount of silver dissolved from an iodine adsorbent having an organic group containing a nitrogen functional group and being free of any organic group containing a sulfur functional group or from an iodine adsorbent having an organic group containing a sulfur functional group and being free of any organic group containing a nitrogen functional group.

### Comparative Example 1

An eggplant-shaped flask (50 mL) equipped with a magnetic stirrer and a Dimroth condenser was charged with 3-mercaptopropyltrimethoxysilane (8.6 g, 44 mmol) and toluene (10 mL), and the mixture was stirred to form a uniform solution. Silica gel (particle size 300 μm to 500 μm, 6.8 g) with a water content of 25% was added to the solution and stirred with heating in an oil bath at 110° C. for 5 hours. After the flask was cooled to room temperature, the silica gel was collected by suction filtration. The silica gel was washed with toluene and then dried under reduced pressure, so that thiol-modified silica gel was obtained as a white powder (yield 6.9 g).

The thiol-modified silica gel (1.9 g) and methanol (20 mL) were added to an eggplant-shaped flask (50 mL) equipped with a magnetic stirrer and a Dimroth condenser. Glucono-δ-lactone (0.48 g, 2.7 mmol) was added to the flask, and the mixture was stirred with heating under reflux for 6 hours. After the flask was cooled to room temperature, the silica gel was collected by suction filtration. The silica gel was washed sequentially with methanol (40 mL) and ion-exchanged water (60 mL) and then dried under reduced pressure, so that thiol-modified silica gel was obtained as a white powder (yield 1.8 g).

The thiol-modified silica gel (0.50 g) was added to a screw vial (20 mL), to which a 3 wt % silver nitrate aqueous solution (10 mL) was added. The vial was tightly capped and then covered with an aluminum foil for light shielding. The mixture was then stirred with a mixing rotor (rotation speed 60 rpm) for 1 hour. The silica gel was collected by suction filtration and then washed with ion-exchanged water until the wash became neutral. After the washing, the silica gel was transferred again to a screw vial (20 mL), which was then charged with ion-exchanged water (10 mL) and tightly capped. The vial was covered with an aluminum foil for light shielding, and the mixture was stirred with a horizontal mixing rotor (rotation speed 60 rpm) for 1 hour. The silica gel was collected by suction filtration, washed thoroughly with ion-exchanged water, and then dried under reduced pressure, so that an iodine adsorbent of Comparative Example 1 was obtained (yield 0.68 g).

[Iodine Adsorption Test]

Potassium iodide (0.500 g) was added to a 1-L measuring flask and diluted to the mark with pure water to form a 500 mg/L potassium iodide aqueous solution. As a solution containing various interfering ions, an artificial seawater-containing 500 mg/L potassium iodide aqueous solution was also prepared by adding potassium iodide (0.500 g) to artificial seawater (1.000 g, MARINE ART SF-1 manufactured by Tomita Pharmaceutical Co., Ltd. (components in 38.4 g of MARINE ART SF-1: NaCl 22.1 g, MgCl₂.6H₂O 9.9 g, CaCl₂. 2H₂O 1.5 g, Na₂SO₄ 3.9 g, KCl 0.61 g, NaHCO₃ 0.19 g, KBr 96 mg, Na₂B₄O₇.10H₂O 78 mg, SrCl₂ 13 mg, NaF 3 mg, LiCl 1 mg, KI 81 μg, MnCl₂.4H₂O 0.6 μg, CoCl₂.6H₂O 2 μg, AlCl₃.6H₂O 8 μg, FeCl₃.6H₂O 5 μg, Na₂WO₄.2H₂O 2 μg, (NH₄)₆Mo₇O₂₄.4H₂O 18 μg)). The two solutions were the solutions to be treated.

Each solution (10 mL) to be treated and the adsorbent (20 mg) were then added to a vial (20 mL), and the mixture was stirred with a mixing rotor under the conditions of 60 rpm and room temperature for 1 hour. After the stirring was completed, the mixture was immediately filtered through a 0.2 μm cellulose membrane filter.

After 0.15 mL of the filtrate was diluted 10 times with 1.35 mL of water, the concentration of iodine in the dilution was determined by ion chromatography. The ion chromatography equipment used was Alliance 2695 manufactured by Waters Corporation. The column used was Shodex IC SI-90 4E, and the eluent used was a 1.8 mM sodium carbonate-1.7 mM sodium hydrogen carbonate aqueous solution. The amount of the adsorbed iodine was calculated from the difference between the concentration of iodine in the solution to be treated and the concentration of the remaining iodide ions in the solution treated in the adsorption test. The amount of the adsorbed iodine was determined based on the amount of the adsorbent used.

When separation between sulfate ions and iodide ions was insufficient, the difference was determined assuming that the sulfate ions were not adsorbed to the adsorbent, when the amount of the adsorbed iodine was determined.

[SEM-EDX Analysis]

In the SEM-EDX analysis, an appropriate amount of the sample was scattered on a carbon tape and directly observed without vapor-deposition of metal or carbon. The SEM was Miniscope TM3000 manufactured by Hitachi High-Technologies Corporation, and the EDX was performed using Quantax 70 manufactured by Burker Corporation. The electron beam acceleration voltage was 15 kV, the observation magnification was 2,000 times, and the observation mode was the secondary electron image mode. The observation was performed on an about 1,250 μm² central area of the silica gel particle. When there was a defect in the central area, the defect was avoided in the measurement. The elements to be subjected to semi-quantitative analysis are Si, O, C, Ag, N, Na, and Cl. If the sample contains sulfur, S will be an additional element to be subjected to the analysis. Four particles in the sample of each of Examples 1 to 7 (three particles in the sample of only Comparative Example 1) were measured, and the average of the measured values was calculated.

A pretreatment was performed as follows. The iodine adsorbent (300 mg) of each of Examples 1 to 7, in which the support contains a nitrogen ligand, was stirred in a saturated aqueous sodium chloride solution (10 mL) for 3 hours (with a mixing rotor) so that the nitrate ions were replaced with the chloride ions. The iodine adsorbent was then washed thoroughly with water and dried under reduced pressure. The iodine adsorbent (300 mg) of Comparative Example 1, which is nitrogen ligand-free, was stirred in an aqueous 3% sodium chloride solution (6 mL) for 1 hour (with a mixing rotor) so that the nitrate ions were replaced with the chloride ions. The iodine adsorbent was then washed thoroughly with water and dried under reduced pressure.

The iodine adsorbents obtained in Examples 1 to 7 and Comparative Example 1 were subjected to the test described above. Table 1 shows the results. Adsorbed amount A is the adsorbed amount (mg-I/g) for the 500 mg/L potassium iodide aqueous solution. Adsorbed amount B is the adsorbed amount (mg-I/g) for the artificial seawater-containing 500 mg/L potassium iodide aqueous solution. Table 2 also shows the concentration (atom % C) of carbon atoms and the atomic concentration ratio (S (atom %)/N (atom %)) of sulfur to nitrogen, which were determined using the SEM-EDX.

TABLE 1

| | Adsorbed amount A | Adsorbed amount B |
|---|---|---|
| Sample | [mg-I/g] | [mg-I/g] |
| Example 1 | 129 | 126 |
| Example 2 | 139 | 137 |
| Example 3 | 142 | 131 |
| Example 4 | 149 | 147 |
| Example 5 | 9.7 | 7.3 |
| Example 6 | 9.8 | 3.7 |
| Example 7 | 118 | 110 |
| Comparative | 7.0 | 27 |
| Example 1 | | |

TABLE 2

| | | Atomic |
|---|---|---|
| | Carbon atom | concentration |
| | concentration | ratio S/N |
| Sample | [atom %] | [−] |
| Example 1 | 19 | 0 |
| Example 2 | 21 | 0.4 |
| Example 3 | 18 | 0.47 |
| Example 4 | 19 | 0.72 |
| Example 5 | 33 | 1.1 |
| Example 6 | 40 | 1.6 |
| Example 7 | 21 | 1.4 |
| Comparative | 18 | — |
| Example 1 | | |

From adsorbed amounts A and B in Table 1, it is apparent that the adsorbent of each of Examples 1 to 4 and 7, containing only a nitrogen ligand or containing a nitrogen ligand and a sulfur ligand, has adsorption performance higher than that of Comparative Example 1. Table 2 shows that the concentration of carbon atoms in Examples 5 and 6, for which the adsorbed amount in Table 1 is relatively small, is 30 to 40 atom %, while the concentration of carbon atoms in Examples 1 to 4 and 7 and Comparative Example 1, for which the adsorbed amount is relatively large, is as low as about 20 atom %. This suggests that as the organic group content increases, the adsorbent increases in hydrophobicity and thus decreases in performance. It is also apparent that for the adsorbents of Examples 1 to 4, adsorbed amount A in Table 1 increases with increasing atomic concentration ratio S/N. For the adsorbents of Examples 2 and 3, which have similar levels of atomic concentration ratio S/N, adsorption amount B increases with decreasing atomic concentration ratio S/N. However, the adsorbents of Examples 3 and 4 all show values higher than the adsorbent of Example 1 containing only a nitrogen ligand. This shows that the use of a combination of a nitrogen ligand and a sulfur ligand makes it possible to improve the performance. A comparison is made among the samples of Examples 2 to 7, which differ only in the mixing ratio of the silane coupling agent. As a result of the comparison, the following has been found. When the concentration of carbon atoms is 21% or less, the amount of the adsorbed iodine increases with increasing sulfur content. Samples with more sulfur functional groups can be synthesized by changing at least the synthesis conditions. Even when the atomic concentration ratio is as high as 1.4, the performance is higher than that when a sulfur ligand is used alone. As the atomic concentration ratio S/N increases to 1.4 as in Example 7, the adsorbed amount slightly decreases but remains higher than that for Comparative Example 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An iodine adsorbent comprising:
a support;
a first organic group bonded to the support and has a functional group containing nitrogen at least at a terminal; and
silver bonded to the nitrogen-containing functional group.

2. The adsorbent according to claim 1, wherein the nitrogen-containing functional group is a functional group having an amine or an amine derivative structure.

3. The adsorbent according to claim 1, wherein the nitrogen-containing functional group includes at least one of an amino group, an amide group, and a guanidino group.

4. The adsorbent according to claim 1, further comprising a second organic group bonded to the support and has a functional group containing sulfur at least at a terminal, and the sulfur-containing functional group includes at least one of a thiol group, a thiolate group, a sulfide group, and a disulfide group.

5. The adsorbent according to claim 4, wherein an atomic concentration ratio (S (atm %)/N (atm %)) of sulfur to nitrogen in the adsorbent is less than 2.0.

6. The adsorbent according to claim 1, wherein the first organic group contains a carbon chain, and a concentration of carbon atoms in the adsorbent is 50 (atm %) or less.

7. The adsorbent according to claim 4, wherein the first organic group contains a carbon chain, the second organic group contains a carbon chain, and a concentration of carbon atoms in the adsorbent is 50 (atm %) or less.

8. A water treatment tank comprising an iodine adsorbent stored therein, wherein
the iodine adsorbent includes a support,
a first organic group bonded to the support and has a functional group containing nitrogen at least at a terminal, and
silver bonded to the nitrogen-containing functional group.

9. The tank according to claim 8, wherein the nitrogen-containing functional group is a functional group having an amine or an amine derivative structure.

10. The tank according to claim 8, wherein the nitrogen-containing functional group includes at least one of an amino group, an amide group, and a guanidino group.

11. The tank according to claim 8, further comprising a second organic group bonded to the support and has a functional group containing sulfur at least at a terminal, and the sulfur-containing functional group includes at least one of a thiol group, a thiolate group, a sulfide group, and a disulfide group.

12. The tank according to claim 11, wherein an atomic concentration ratio (S (atm %)/N (atm %)) of sulfur to nitrogen in the adsorbent is less than 2.0.

13. The tank according to claim 8, wherein the first organic group contains a carbon chain, and a concentration of carbon atoms in the adsorbent is 50 (atm %) or less.

14. The tank according to claim 11, wherein the first organic group contains a carbon chain, the second organic group contains a carbon chain, and a concentration of carbon atoms in the adsorbent is 50 (atm %) or less.

15. An iodine adsorbing system comprising:
an adsorbent unit having an iodine adsorbent;
a supply unit configured to supply, to the adsorbent unit, target medium water containing an iodide;
a discharge unit configured to discharge the target medium water from the adsorbent unit;
a measuring unit provided on at least one of supply and discharge sides of the adsorbent unit and configured to measure a concentration of the iodide in the target medium water; and
a controller configured to control a flow of the target medium water from the supply unit to the adsorbent unit when a value calculated or obtained from a measured value in the measuring unit reaches a set value, wherein
the iodine adsorbent includes a support,
a first organic group bonded to the support and has a functional group containing nitrogen at least at a terminal, and
silver bonded to the nitrogen-containing functional group.

16. The system according to claim 15, wherein the nitrogen-containing functional group is a functional group having an amine or an amine derivative structure.

17. The system according to claim 15, wherein the nitrogen-containing functional group includes at least one of an amino group, an amide group, and a guanidino group.

18. The system according to claim 15, further comprising a second organic group bonded to the support and has a functional group containing sulfur at least at a terminal, and the sulfur-containing functional group includes at least one of a thiol group, a thiolate group, a sulfide group, and a disulfide group.

19. The adsorbent according to claim 15, wherein the first organic group contains a carbon chain, and a concentration of carbon atoms in the adsorbent is 50 (atm %) or less.

20. The system according to claim 18, wherein an atomic concentration ratio (S (atm %)/N (atm %)) of sulfur to nitrogen in the adsorbent is less than 2.0, and the first organic group contains a carbon chain, the second organic group contains a carbon chain, and a concentration of carbon atoms in the adsorbent is 50 (atm %) or less.
